(19) United States
(12) Patent Application Publication
(10) Pub. No.: US 2011/0145113 A1
(43) Pub. Date: Jun. 16, 2011

(54) Portable electronic checkbook with security identification protocols

(76) Inventor: Thomas Twum, Lakehurst, NJ (US)

(21) Appl. No.: 12/658,720

(22) Filed: Feb. 16, 2010

Related U.S. Application Data
(60) Provisional application No. 61/284,091, filed on Dec. 14, 2009.

(51) Int. Cl. G06Q 40/00

(52) U.S. Cl. 705/33

(57) ABSTRACT

A portable electronic checkbook having a security identification scanner to prevent its use by an unauthorized person, the electronic checkbook having a cassette slidably receivable therein containing check quality paper, and a means for activating the checkbook, entering data with respect to a check to be written and printing and dispensing the check subject to identification verification,

### RELATED APPLICATIONS

Applicant claims the benefit of provisional application Ser. No. 61/284,091, filed Dec. 14, 2009.

### BACKGROUND OF THE INVENTION

1. Field of the Invention

The present invention relates to checkbooks, and in particular, to a computerized electronic checkbook which can be carried by the person and which can generate a printed check at the direction of the owner of the checkbook subject to owner security ID protocols incorporated in the checkbook.

2. Description of the Prior Art

Handwritten paper checks and their associated checkbooks have been in existence and use for many years. The most common type of checkbook is the personal checkbook, which measures approximately six inches, by three inches, having a flexible cover which houses a ledger book in which the individual keeps track of the number of the check, the date of the check, and the payee of the check and the amount of the check written. The checkbook also includes a pad-like insert which has affixed thereto a plurality of preprinted checks with the account number and other indicia which the owner/user may desire, such as name, address, phone number, etc., and a format for filling out the check, including the date, the amount, the payee, the reference, and the signature of the checkbook owner/user.

People commonly carry this type of checkbook with them on a regular basis when they may wish to write a check to pay for services and/or goods, at which time they would remove the checkbook, make the appropriate notations in the ledger sheet and write the check and present it.

The problem with this type of check book is that it is easily susceptible to pickpockets, misplacement, and subsequent fraudulent use. Even if it is lost or stolen and is immediately recognized and reported, it is not unlikely that at least one or two fraudulent checks may be presented and cashed with respect to the account in question.

There therefore has been a need for a portable electronic checkbook with appropriate security indicia which would allow an individual to present checks for goods or services without fear that the checkbook or individual checks might be lost, forged and fraudulently presented.

The capability exists in the computer age to generate checks from your computer at home, which is satisfactory if you know the exact amount and wish to preprint the check before presenting it. However, many people use their personal checkbooks for purchases at the spur of the moment, and their home computer is not readily available to them to create the appropriate check. Applicant's device presents an electronic checkbook proximating the size of the standard, personal checkbook with an LCD screen and keypad and paper cassette and associated security indicia device which allows only the authorized owner/user to enter the date, amount, payee, and signature and to authorize by laser security the checkbook to print an individualized check on a piece of blank paper stored in the paper cartridge, and to dispense the check from the electronic checkbook for presentment to the payee.

### OBJECTS OF THE INVENTION

An object of the present invention is to provide for a novel portable electronic checkbook having a security identification scanner to prevent its use by an unauthorized person, the electronic checkbook having a cassette slidably receivable therein containing check quality paper, and a means for activating the checkbook, entering data with respect to a check to be written and printing and dispensing the check subject to identification verification, the electronic checkbook having a rechargeable power source.

Another object of the present invention is to provide for an electronic checkbook in which the entry of data is accomplished by means of a keyboard.

A still further object of the present invention is to provide for a novel electronic checkbook in which the entry of data is accomplished by means of a handwriting recognition screen and a stylus.

A still further object of the present invention is to provide for a novel electronic checkbook which is inoperable and useless to another party without the proper identification verification programmed within the electronic checkbook.

### SUMMARY OF THE INVENTION

A portable electronic checkbook having a security identification scanner to prevent its use by an unauthorized person, the electronic checkbook having a cassette slidably receivable therein containing check quality paper, and a means for activating the checkbook, entering data with respect to a check to be written and printing and dispensing the check subject to identification verification, the electronic checkbook having a rechargeable power source.

### BRIEF DESCRIPTION OF THE DRAWINGS

These and other objects of the present invention will become apparent, particularly when taken in light of the following illustrations wherein:

FIG. 1 is a perspective view of an electronic checkbook of the present invention;

FIG. 2 is a perspective exploded view of an electronic checkbook of the present invention;

FIG. 3 is a first end view of an electronic checkbook of the present invention;

FIG. 4 is a second end view of an electronic checkbook of the present invention; and

FIG. 5 is a perspective view of a second embodiment of an electronic checkbook of the present invention.

### DETAILED DESCRIPTION OF THE INVENTION

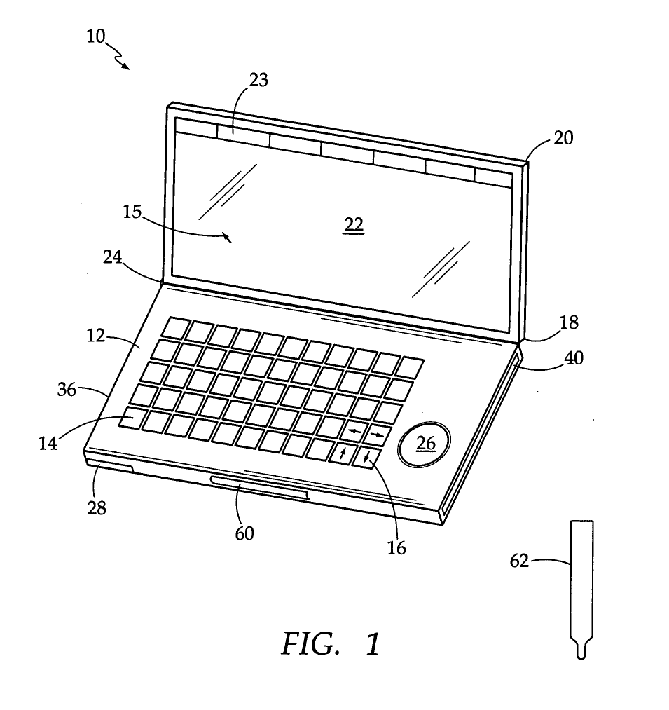

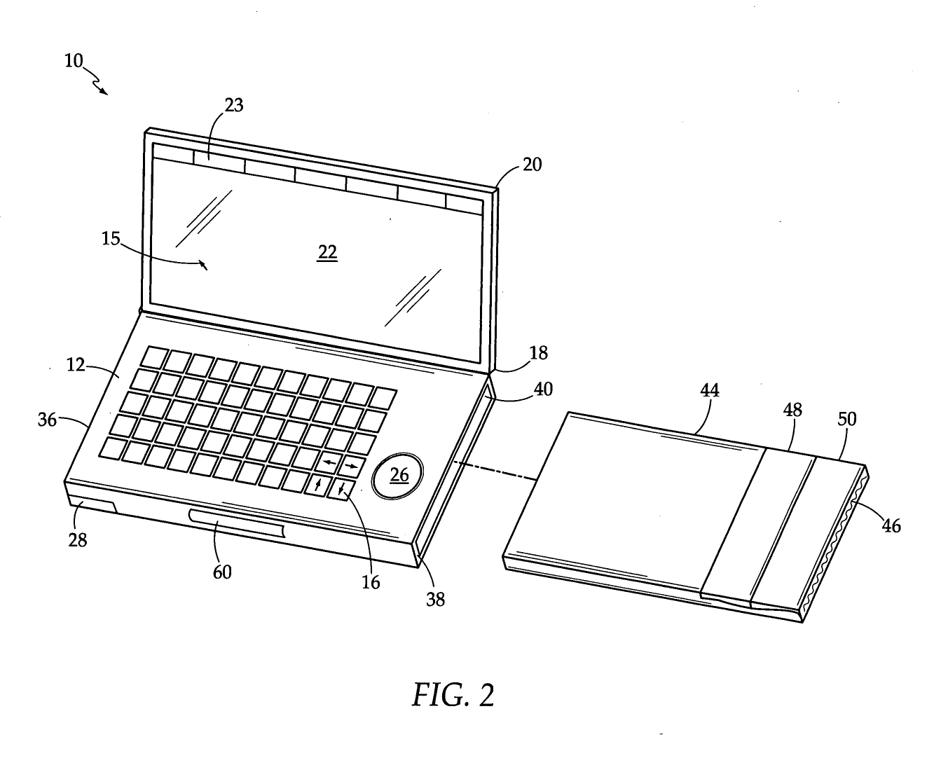

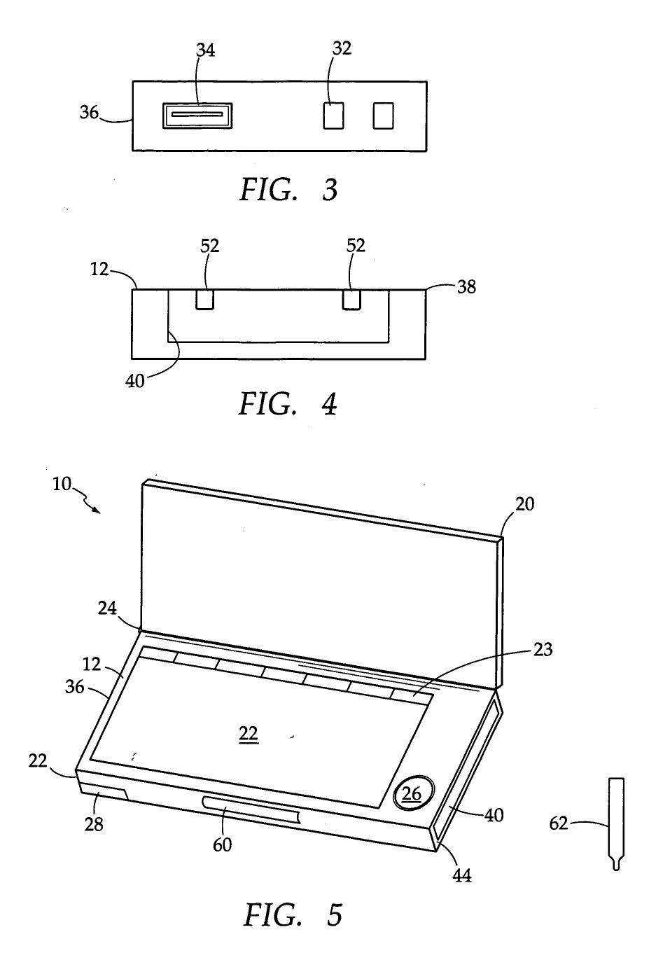

FIG. 1 is a perspective view of a first embodiment of the electronic checkbook 10 of the present invention, FIG. 2 is a perspective exploded view of a first embodiment of the electronic checkbook 10 of the present invention, and FIGS. 3 and 4 are respective end views of the first embodiment of the electronic checkbook 10 of the present invention.

The electronic checkbook 10 comprises a base member 12 upon which is located an alpha-numeric keyboard panel 14 which may contain cursor 15 control arrow keys 16. The base member 12 is hingeably secured along a longitudinal edge 18 to an upper lid panel 20 which incorporates an LCD display screen 22. Base member 12 and lid panel 20 are foldable upon themselves along hinge member 24 for a closed orientation and rotatable to a 180 degree orientation to fully open. The base member 12 or the lid panel 20 is formed with an identification verification window 26 in order to activate the electronic checkbook 10 and in order to enter data and print checks as more fully described hereafter.

Base member 12 is also formed with a cavity 28 for receipt of a rechargeable battery power source (not shown), which can be secured by appropriate communication means 32 to a power source. Base member 12 is also formed with a USB connection 34 which will allow the electronic checkbook 10 to be in electronic secure communication with a personal computer or equivalent for the transfer of data from the electronic checkbook 10 to the personal computer. These power connections and data of transfer connections would preferably be formed in first lateral end 36 of the electronic checkbook 10 as illustrated in FIG. 3.

An opposing lateral end 38 would be formed with a slot 40 defining a cavity 42 within the base member 12 for receipt of a slidable cassette member 44. Slidable cassette member 44 is dimensioned to receive a plurality of check quality paper sheets 46 dimensioned to the size of a personal check, but having no printing or indicia thereon. This check quality paper 46 would be preloaded into cassette member 44 by the user and would be limited in quantity only by the thickness of the base member 12 of the electronic checkbook 10. The cassette member 44 would also incorporate an ink receptacle 48 which could be either refillable or replaceable in communication with an ink jet or laser printer means 50.

Also positioned within the slot 40 formed in base member 12 would be a plurality of transport belts and rollers 52 which in operation would engage the end of the uppermost check quality paper 46 in the cassette member 44 and transport it of the cassette and dispense the check from the electronic checkbook 10, once the check was printed.

The rechargeable power source within the electronic checkbook 10 would be in communication with an internal memory chip which in turn would be in communication with the display screen, transport means, keyboard, and security means.

In operation, the user would visit his or her local bank for the programming of the electronic checkbook. The electronic checkbook 10 would be in electronic communication with a bank computer which would allow entry into the memory chip of data relating to the form of the check, the names on the check, the bank account and routing numbers and bank numbers associated with the account and the check numbers and would allow for the set up of the identification verification reader scanner in association with identification verification window 26. The identification verification reader scanner would operate on a variety of principals, but one of the simplest would be with respect to a thumb print.

Once this information had been entered into the memory chip, the user would purchase a quantity of check quality paper from the bank and proceed to load the cassette member 44 before utilization of the electronic checkbook 10.

In one example, the user may wish to pay for goods or services by check at a particular store. The user would open the electronic checkbook 10 by opening base member 12 or keyboard panel 14 from the lid panel 20 and display screen 22 by means of hinge member 24. The user would then activate the electronic checkbook 10 by placing the appropriate finger and fingerprint onto the identification/verification window 26. This would activate the device and display a menu/task bar 23 on the display screen 22. The user would then utilize the keyboard panel 14 to enter the required data in order to fill out the check with the Payee's name, the date, and the amount. Activation of the identification verification scanner would then cause the miniaturized printer 50 via the ink receptacle 48 to print the check as the transport belts and rollers 52 move the upper sheet of check quality paper 46 outwardly from the cassette member 44 at the lateral end of the electronic checkbook 10. The user would then merely sign the dispensed check and present it to the payee.

The memory chip would be programmed such that once a check had been dispensed, the memory chip would immediately erase the identification verification from memory to prevent additional printing of checks without commencing the process anew. If the user wished to write a second check at another location, or at the same location, the user would have to commence the process anew. The memory chip and the menu and task bar allow the user to retain data related to the transactions such as the check number, the amount, the payee, the date, and deposits made, or any checks voided. This information will be available on the display screen 22 only to the user with the proper verification identification. In this manner, the user may use the electronic check book 10 for a period of time until the quantity of check quality paper 46 has been depleted, at which time it can be refilled. The user can further download the data stored on the electronic check book to his home personal computer or other desired central processing unit utilizing the USB 34 connection.

The menu/task bar 23 on the display screen 22 can be manipulated in this embodiment by the keyboard panel 14, directional keys 16, and cursor 15, or an icon can be present on the screen panel, which can be manipulated by a stylus 62 which can be slidably received within its own receptacle 60 on the electronic checkbook 10.

FIG. 5 indicates a second embodiment of the electronic checkbook 10 of the present invention. With the advancement of voice recognition technology and the advancement of handwriting recognition technology, the electronic checkbook 10 could be fabricated in a manner similar to the first embodiment, but with the elimination of the keyboard panel 14. In this embodiment, the display screen 22 would be embodied in the base member 12 along with the other elements associates with the first embodiment. In this second embodiment, the identification verification window 26, upon activation would cause a check template (originally established with connection to bank computer) to appear on the screen panel 22. The user would then use a stylus 62 to write in the date, the payee, amount, and sign his or her signature. Activation of the identification verification reader/scanner would then cause the printer to dispense a check incorporating the memory installed template with the handwritten signature, amounts, payee and date, already recorded.

This second embodiment could also incorporate a menu/task bar 23, which would allow the user to utilize stylus 62 in order to review the number of checks written, the amounts, the payees, the dates, and also to input deposits and account for a void check.

The portable electronic checkbook 10 has been described thus far with respect to usage with a single bank. However, the portable electronic checkbook 10 could also be utilized with multiple banks, and multiple accounts, as long as the user presented the portable electronic checkbook to each appropriate bank so that each of the accounts could be identified and downloaded into the memory chip. In this manner, once the user supplied the appropriate security identification to the checkbook, the user then could select the desired bank and/or account to be debited using either the keyboard or the stylus and LCD screen. The user would then enter the information and the memory chip would cause a check on the appropriate bank and/or account to be printed and disbursed from the electronic checkbook. The electronic checkbook would be programmed at each bank or for each account at the bank. As an alternative, if the user desired to distinguish different banks and/or accounts, the user could utilize multiple cassettes with each cassette loaded with bank check paper of a different color. In either instance, the electronic checkbook, and the memory chip, and the check template would operate as described heretofore.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A portable electronic checkbook having security identification protocols, said portable electronic checkbook comprising:
a housing member, said housing member having an LCD screen, a data input means, a preprogrammed memory card, a user identification means cooperable with said preprogrammed memory card for on/off operation of said portable electronic checkbook, and the entry and output of data, a power source, and a receptacle cassette slot; and
a cassette member slidably receivable within said cassette slot of said housing member, said cassette fillable with a plurality of blank check paper, said cassette member having a printing means and ink receptacle and transport means, said printing means and transport means in communication with said power source of said housing member when said cassette is fully inserted into said cassette slot, said printer member and said transport member cooperating to disburse a single check paper containing all appropriate banking data, payer data, payee data, and amounts, from said cassette for presentment, after appropriate identification from said identification means to said memory chip and the entry of appropriate data by said data entry means.

2. The portable electronic checkbook in accordance with claim 1 wherein said memory chip is preprogrammed with the appropriate bank account data and is preprogrammed to be responsive to a single identification indicia presented to said identification means on said housing and recognizable by said memory chip.

3. The portable electronic checkbook in accordance with claim 2 wherein said identification means comprises a fingerprint of said authorized user.

3. The portable electronic checkbook in accordance with claim 1 wherein said data entry means comprises a qwerty keyboard.

4. The portable electronic checkbook in accordance with claim 1 wherein said data entry means comprises a writable LCD screen.

5. The portable electronic checkbook in accordance with claim 2 wherein said memory card is preprogrammed with bank account data and authorized user's security identification and indicia.

6. The portable electronic checkbook in accordance with claim 2 wherein said memory chip computes a running balance of said bank account based upon usage of said portable electronic checkbook and displays said balance on said LCD screen in response to an authorized user security identification indicia.

7. The portable electronic checkbook in accordance with claim 1 wherein said printer ink cartridge in said cassette member is replaceable.

8. The portable electronic checkbook in accordance with claim 2 wherein said bank account data information and user security identification indicia are established between said user and a bank prior to the issuance of said portable electronic checkbook, said information secured on said memory chip.

9. The portable electronic checkbook in accordance with claim 1 wherein said plurality of check writing blanks loaded in said cassette member comprise check quality paper of check quality size in a blank format, said check to be printed after appropriate entry of data and the establishment of the user security identification indicia.
